(19) United States
(12) Patent Application Publication
(10) Pub. No.: US 2016/0200281 A1
(43) Pub. Date: Jul. 14, 2016

(54) AIRBAG APPARATUS AND VEHICLE EQUIPPED WITH SAME

(71) Applicant: MAZDA MOTOR CORPORATION, Hiroshima (JP)

(72) Inventors: Hiroaki Takeshita, Aki-gun (JP); Takashi Nagatani, Hiroshima-shi (JP); Ryusuke Asahi, Hiroshima-shi (JP); Ichiro Kamimoto, Hiroshima-shi (JP); Motoharu Hirata, Hatsukaichi-shi (JP); Mitsutoshi Yamanishi, Higashihiroshima-shi (JP); Kenta Azuma, Hiroshima-shi (JP)

(73) Assignee: MAZDA MOTOR CORPORATION, Hiroshima (JP)

(21) Appl. No.: 14/985,865

(22) Filed: Dec. 31, 2015

(30) Foreign Application Priority Data
Jan. 13, 2015 (JP) 2015-004043

(51) Int. Cl. B60R 21/231; B62D 1/11

(52) U.S. Cl. CPC B60R 21/23138; B62D 1/11; B60R 2021/23107

(57) ABSTRACT

An airbag apparatus includes a first airbag (10) that deploys rearward from a position in front of an occupant (D) upon an oblique collision and a second airbag (20) that deploys so as to cover a cabin side wall upon an oblique collision. The second airbag (20) includes a wraparound portion (23) which deploys so as to protrude towards the inside of the cabin at a position further on the front side from an outer edge portion (10a) that is a portion, opposing the cabin side wall, of a peripheral edge of the deployed first airbag (10) to restrict the outer edge portion (10a) from being displaced forward.

### TECHNICAL FIELD

The present invention relates to an airbag apparatus for protecting an occupant upon an oblique collision of a vehicle and a vehicle equipped with the airbag apparatus.

### BACKGROUND ART

When an oblique collision accident occurs in which a colliding object collides with a vehicle from obliquely in front of the vehicle, an occupant is thrust obliquely forward from an initial position (seated position). Conventionally, in order to protect an occupant when such an oblique collision accident occurs, airbags are deployed both in front and to the side of the occupant.

For example, a vehicle disclosed in Japanese Unexamined Patent Publication No. 2013-133049 is equipped with a front airbag that deploys rearward from an instrument panel arranged at a front end of a cabin and a side airbag that deploys downward from a lateral side portion of an upper surface of the cabin (a pillar or a roof side rail).

According to the technique described in Japanese Unexamined Patent Publication No. 2013-133049, even if an occupant is thrust obliquely forward due to an oblique collision, the head of the occupant or the like can be received by the front airbag and the side airbag, and the occupant can be protected.

However, with Japanese Unexamined Patent Publication No. 2013-133049, there is a possibility that an occupant cannot be properly received (cannot be sufficiently restrained). For example, when the occupant's head comes into contact with the front airbag in an obliquely forward direction, the front airbag is expected to deform by inclining sharply in response to an obliquely forward load input to the front airbag from the head making contact. Once such a deformation occurs, since the occupant's head is prone to move in a lateral direction along a rear surface of the front airbag (in other words, from a central portion to a peripheral edge portion of the front airbag), the front airbag can no longer receive the occupant's head with sufficient counter force and may lose the ability to appropriately protect the occupant.

### SUMMARY OF INVENTION

The present invention has been made in consideration of the circumstances described above and an object thereof is to appropriately protect an occupant upon an oblique collision of a vehicle using an airbag apparatus.

In order to solve the problem described above, the present invention provides an airbag apparatus for protecting an occupant upon an oblique collision of a vehicle or a vehicle equipped with the airbag apparatus. The airbag apparatus includes a first airbag which is provided in front of the occupant and which deploys rearward upon an oblique collision and a second airbag which is provided on the lateral side of the occupant and which deploys so as to cover a cabin side wall upon an oblique collision. The second airbag includes a wraparound portion which deploys so as to protrude towards the inside of the cabin at a position further on a front side from an outer edge portion that is a portion, opposing the cabin side wall, of a peripheral edge of the deployed first airbag to restrict the outer edge portion from being displaced forward.

### BRIEF DESCRIPTION OF DRAWINGS

FIG. 1 is a side view showing the inside of a cabin of a vehicle to which an airbag apparatus according to an embodiment of the present invention is applied;

FIG. 2 is a plan view of the inside of the cabin;

FIGS. 3A and 3B are diagrams for explaining a structure of a driver's airbag, wherein FIG. 3A is a front view and FIG. 3B is a sagittal sectional view taken along α-α in FIG. 3A;

FIGS. 4A and 4B are diagrams for explaining a structure of a curtain airbag, wherein FIG. 4A is a side view and FIG. 4B is a sagittal sectional view taken along β-β in FIG. 4A;

FIG. 5 is an explanatory diagram depicting an oblique collision accident of a vehicle;

FIG. 6 is a first correspondence diagram showing a state where a driver's airbag and a curtain airbag have deployed upon an oblique collision of a vehicle;

FIG. 7 is a second correspondence diagram showing a state where a driver's airbag and a curtain airbag have deployed upon an oblique collision of a vehicle;

FIGS. 8A and 8B are explanatory diagrams for explaining operations of the embodiment described above, wherein FIG. 8A shows a state prior to a forward movement of a steering wheel and FIG. 8B shows a state after a forward movement of the steering wheel; and

FIG. 9 is an explanatory diagram for explaining a comparative example of the present invention.

### DESCRIPTION OF EMBODIMENTS

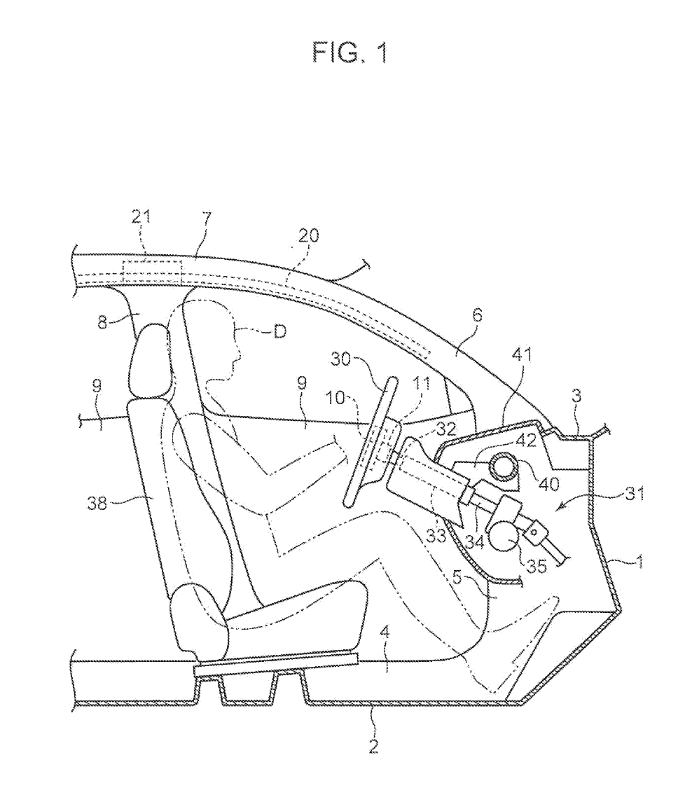

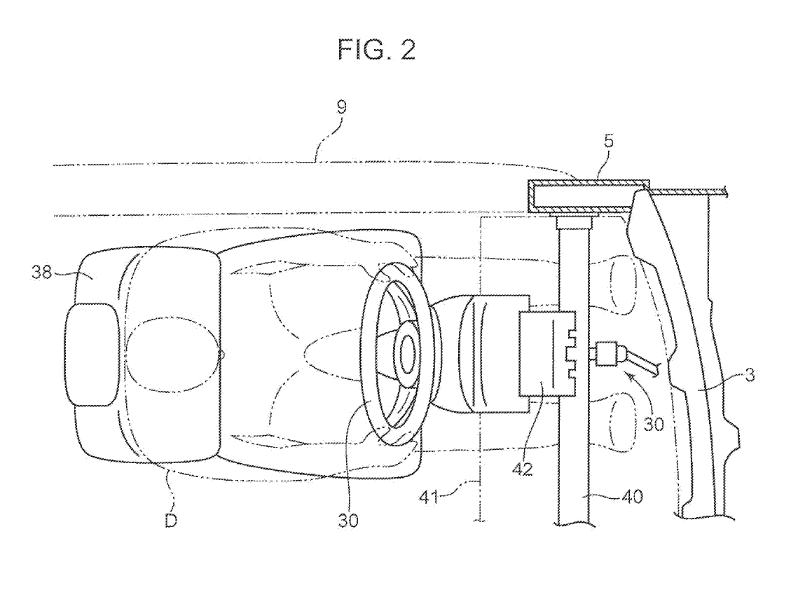

FIGS. 1 and 2 show a configuration of the inside of a cabin of a vehicle to which an airbag apparatus according to an embodiment of the present invention is applied. While the side view in FIG. 1 only shows a left-side face of the cabin, a right-side face of the cabin shares a similar configuration.

As mainly shown in FIG. 1, a vehicle according to the present embodiment includes a dash panel 1 that acts as a partition between an engine room and the cabin, a floor panel 2 that extends rearward from a lower end portion of the dash panel 1, a cowl panel 3 provided at an upper end portion of the dash panel 1, a pair of side sills 4 extending in a longitudinal direction along left and right lateral side portions of the floor panel 2, a pair of hinge pillars 5 each extending upward from a front end portion of each side sill 4, a pair of front pillars 6 each incliningly extending rearward and upward from an upper end portion of each hinge pillar 5, a pair of roof side rails 7 each extending rearward from an upper end portion of each front pillar 6, a pair of center pillars 8 each extending in a vertical direction so as to connect a central portion of each roof side rail 7 in a longitudinal direction and each side sill 4 to each other, and a plurality of side doors 9 that respectively openably and closably cover a plurality of boarding/disembarking openings partitioned and formed to the front and rear of each center pillar 8.

An instrument panel member 40 for supporting an instrument panel 41 is attached to the front end portion of the cabin. The instrument panel member 40 is provided so as to extend in a vehicle width direction, and both end portions thereof are respectively connected to the pair of hinge pillars 5.

A driver's seat 38 to be sat on by a driver (driver's seat occupant) D is mounted to an upper surface of the floor panel 2. In addition, a steering wheel 30 to be grasped and operated by the driver D is provided in front of the driver's seat 38.

The steering wheel 30 is supported by the instrument panel member 40 via a steering wheel support mechanism 31. Specifically, the steering wheel support mechanism 31 includes a steering shaft 32 fixed to the steering wheel 30, a cylindrical outer column 33 that rotatably supports the steering shaft 32 around its axis, an inner column 34 fitted into the outer column 33, and an electrically-powered assist mechanism 35 (electric power steering device) mounted to the inner column 34. The outer column 33 is fixed to the instrument panel member 40 via a bracket 42.

In the present embodiment, the steering wheel support mechanism 31 is equipped with a shock absorbing function that causes the steering wheel 30 to move forward by a prescribed amount in the event of collision of the vehicle. While various specific configurations may be adopted to realize the shock absorbing function, for example, the outer column 33 and the bracket 42 may conceivably be connected to each other via a shearing pin. Upon collision of the vehicle, the shearing pin breaks and the outer column 33 disengages from the bracket 42. As a result, the outer column 33 slides forward along the inner column 34 and causes the steering wheel 30 to move forward.

A driver's airbag 10 and an inflator 11 that supplies inflating gas to the driver's airbag 10 are provided inside the steering wheel 30. In addition, a curtain airbag 20 and an inflator 21 that supplies inflating gas to the curtain airbag 20 are provided inside the front pillar 6 and the roof side rail 7. Moreover, the driver's airbag 10 corresponds to the first airbag described in the Claims and the curtain airbag 20 corresponds to the second airbag described in the Claims.

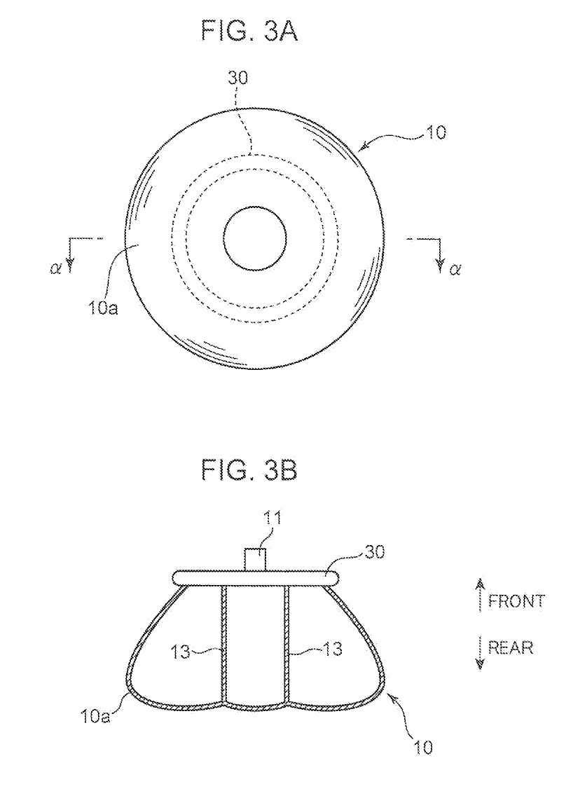

The driver's airbag 10 is housed in a folded state inside the steering wheel 30. The inflator 11 is activated when a front collision of the vehicle is detected by a front collision sensor (not shown) constituted by, for example, a longitudinal G sensor, and instantaneously supplies inflating gas to the driver's airbag 10. The driver's airbag 10 receives the supply of inflating gas and expands so as to deploy rearward from the steering wheel 30 (refer to FIGS. 3A, 3B, 6, and 7). The deployed driver's airbag 10 is arranged between the steering wheel 30 and the head of the driver D and prevents the head of the driver D and the like from colliding with the steering wheel 30.

FIGS. 3A and 3B are, respectively, a front view and a sectional view showing a state after deployment of the driver's airbag 10. As shown in the diagrams, the driver's airbag 10 is formed so as to have an approximately conical shape in a sectional view in a deployed state where the driver's airbag 10 is deployed rearward. In addition, the driver's airbag 10 includes a tether 13 that partitions internal space of the driver's airbag 10 into a plurality of sections. In the illustrated example, the tether 13 is attached so as to longitudinally connect an outer skin material of the driver's airbag 10 with the steering wheel 30. Since the tether 13 serves to restrict an amount of deployment of a central portion of the driver's airbag 10, a rear surface (a surface opposing the driver D) of the driver's airbag 10 during deployment is formed as a whole in a shape relatively more similar to a flat surface (disk) than to a convex spherical surface that protrudes rearward. This means that the head of the driver D can be received by a relatively large surface and, in turn, the driver D can be protected more appropriately.

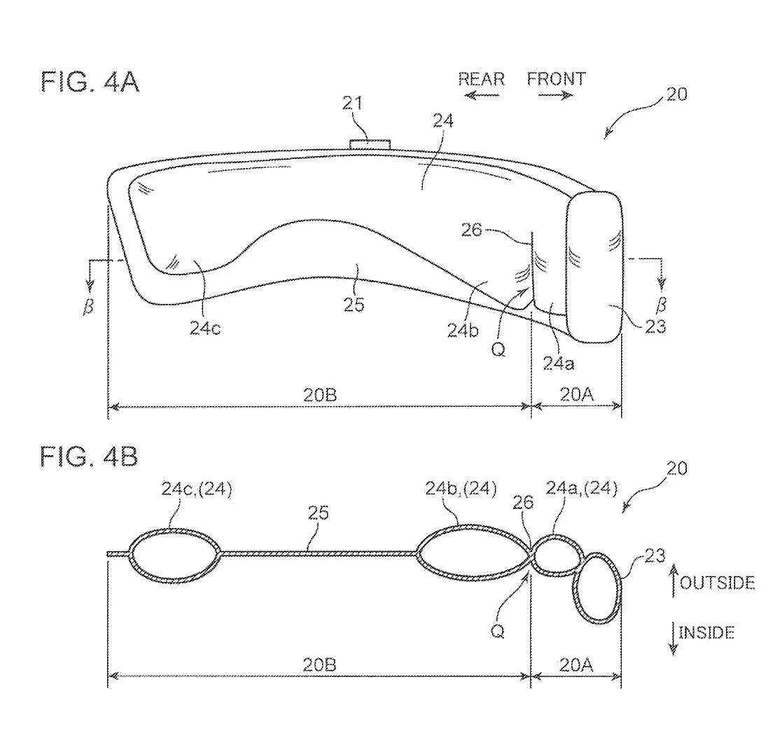

As shown in FIG. 1, the curtain airbag 20 is housed in a folded state inside the front pillar 6 and the roof side rail 7. The inflator 21 is activated when a side collision of the vehicle is detected by a side collision sensor (not shown) constituted by, for example, a lateral G sensor, and instantaneously supplies inflating gas to the curtain airbag 20. The curtain airbag 20 receives the supply of inflating gas and expands so as to deploy downward from the front pillar 6 and the roof side rail 7 (refer to FIGS. 4A, 4B, 6, and 7). The deployed curtain airbag 20 is arranged so as to cover a cabin side wall constituted by an inner surface of the side door 9 and the like and prevents the driver D from colliding with the cabin side wall.

FIGS. 4A and 4B are, respectively, a side view and a sectional view showing a state after deployment of the curtain airbag 20. As shown in the drawings, the curtain airbag 20 integrally includes a sheet-like base portion 25 that does not contain space to be filled by inflating gas and bag bodies (23 and 24) that contain space to be filled by inflating gas. The bag bodies include a front end cell portion 23 (corresponding to the wraparound portion described in the Claims) that expands and deploys so as to extend vertically at a front end portion of the curtain airbag 20, and a main bag body 24 that expands and deploys so as to spread over a relatively wide range to the rear side of the front end cell portion 23. The front end cell portion 23 and the main bag body 24 are formed so that respective inner spaces thereof are communicated with each other via a communicating portion (not shown).

As shown in the side view in FIG. 4A, the main bag body 24 is formed so that a vertical width of a central portion thereof in a longitudinal direction is smaller than those of other locations. In other words, the main bag body 24 is formed so that a lower side portion thereof protrudes upward in a side view. In addition, the main bag body 24 includes a partition portion 26 connected to a front portion of the main bag body 24 by means such as sewing. The partition portion 26 is formed so as to extend upward from a lower side of the front portion of the main bag body 24. However, the partition portion 26 does not reach an upper side of the main bag body 24 and is formed so as to connect only a part of the vertical width at the front portion of the main bag body 24. Therefore, an interior of the main bag body 24 includes spaces that are communicated with each other to form an integral space.

The curtain airbag 20 structured as described above has a shape resembling four cells tied in a row in a sectional view obtained by cutting the curtain airbag 20 at a height position of the partition portion 26 (a sagittal section taken along β-β in FIG. 4A). In other words, in the sectional view shown in FIG. 4B, the curtain airbag 20 includes the front end cell portion 23 described above and three cell portions 24a, 24b, and 24c of the main bag body 24 divided by the partition portion 26 and the base portion 25. Hereinafter, among the cell portions of the main bag body 24, the foremost cell portion 24a will be referred to as a first front cell portion, the cell portion 24b adjacently formed to the rear side of the first front cell portion 24a will be referred to as a second front cell portion, and the cell portion 24c formed to the rear side of the second front cell portion 24b while being separated from the second front cell portion 24b will be referred to as a rear cell portion.

The first front cell portion 24a, the second front cell portion 24b, and the rear cell portion 24c are arranged so as to line up approximately in a longitudinal direction along the cabin side wall. On the other hand, the front end cell portion 23 is arranged so as to protrude further towards the inside of the cabin (inward in the vehicle width direction) than any of the cell portions 24a, 24b, and 24c.

As described above, the first front cell portion 24a and the second front cell portion 24b are adjacent to each other across the partition portion 26. As a result, the main bag body 24 includes a recessed portion Q that is recessed towards the outside of the vehicle (towards the cabin side wall) at a portion located between the first and second front cell portions 24a and 24b of the surface of the main bag body 24 on a cabin inner side.

Next, operations of the driver's airbag 10 and the curtain airbag 20 upon an oblique collision of the vehicle will be described. In the following description, a portion of the curtain airbag 20 further on a front side from the partition portion 26 will be referred to as a front area portion 20A and a portion of the curtain airbag 20 further on a rear side from the partition portion 26 will be referred to as a rear area portion 20B. While details will be provided later, the front area portion 20A is a portion formed on the front side of the driver's airbag 10 during deployment and the rear area portion 20B is a portion formed to the rear side of the driver's airbag 10 during deployment. The front area portion 20A includes the front end cell portion 23 and the first front cell portion 24a, and the rear area portion 20B includes the second front cell portion 24b and the rear cell portion 24c.

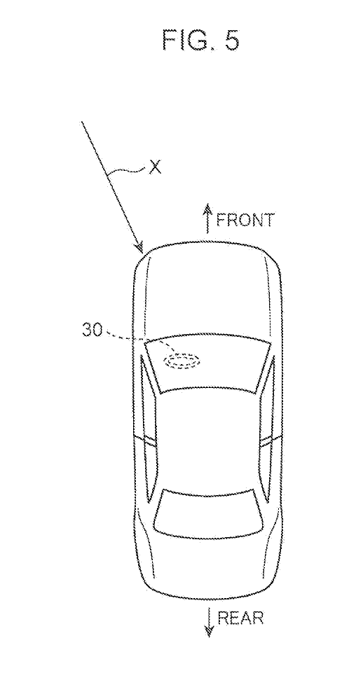

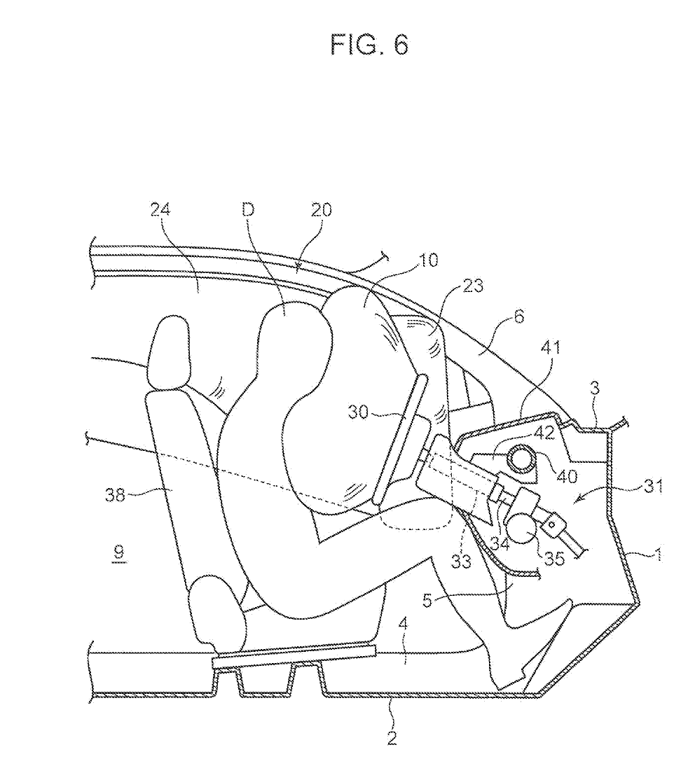

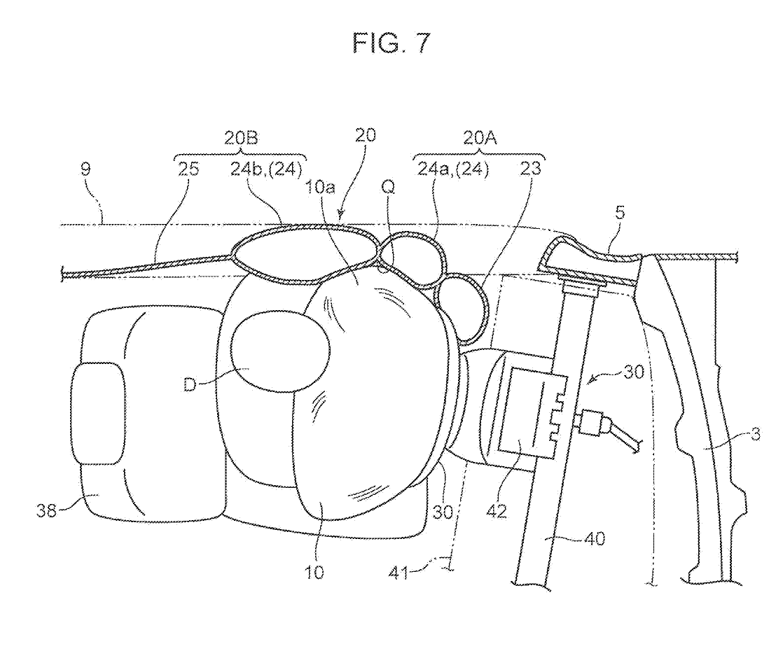

As shown in FIG. 5, when a colliding object such as another vehicle or an obstacle collides with the vehicle from obliquely in front on the side of the driver's seat (obliquely front and left in the drawing) or, in other words, when an oblique collision accident of the vehicle occurs, an obliquely rearward impact load X acts on the vehicle. Upon receiving the impact load X, the vehicle experiences a large rearward and lateral acceleration. As a result, the acceleration is detected by the front collision sensor and the side collision sensor described earlier (in other words, it is interpreted that a front collision and a side collision of the vehicle have occurred simultaneously) and, consequently, the respective inflators 11 and 21 of the driver's airbag 10 and the curtain airbag 20 are activated. Subsequently, as shown in FIGS. 6 and 7, the activation of the inflators 11 and 21 causes the driver's airbag 10 to deploy rearward from the steering wheel 30 and the curtain airbag 20 to deploy downward from the front pillar 6 and the roof side rail 7. Moreover, while the curtain airbag 20 is also provided on an opposite side of the illustrated cabin side surface (the left-side side surface), the opposite-side curtain airbag may or may not be deployed. In other words, upon an oblique collision of the vehicle, at least the curtain airbag 20 provided on the side to which a colliding object has collided is deployed.

Upon an oblique collision of the vehicle as described above, by deploying so as to protrude towards the inside of the cabin, particularly the front end cell portion 23 of the front area portion 20A of the curtain airbag 20 is arranged so as to fill a space on a back surface side of the driver's airbag 10 or, in other words, to fill a space between the driver's airbag 10 and the instrument panel 41.

As shown in FIGS. 3A, 3B, and 7, a portion opposing a cabin side wall of a peripheral edge of the deployed driver's airbag 10 (more specifically, a portion most proximal to the cabin side wall and a vicinity of the portion) will be referred to as an outer edge portion 10a. The curtain airbag 20 deploys as follows in relation to the outer edge portion 10a. That is, as particularly shown in FIG. 7, the curtain airbag 20 deploys so that the front area portion 20A thereof is arranged to the front side of the outer edge portion 10a of the driver's airbag 10 and the rear area portion 20B thereof is arranged to the rear side of the outer edge portion 10a of the driver's airbag 10.

Due to the driver's airbag 10 and the curtain airbag 20 deploying in a positional relationship described above, the outer edge portion 10a of the driver's airbag 10 penetrates into the recessed portion Q of the curtain airbag 20 or, in other words, penetrates into the recessed portion Q formed between the front area portion 20A and the rear area portion 20B.

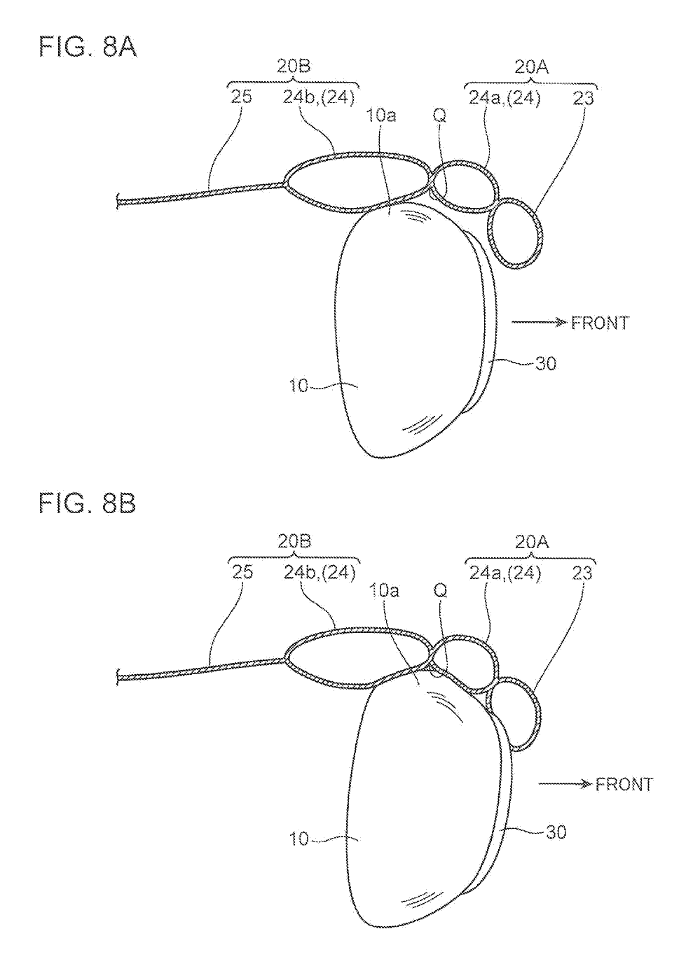

More specifically, the positional relationship between the driver's airbag 10 and the curtain airbag 20 is set to a relationship that causes the outer edge portion 10a of the driver's airbag 10 to sufficiently penetrate into the recessed portion Q of the curtain airbag 20 in a state where the steering wheel 30 has moved forward upon an oblique collision. In other words, in the present embodiment, when the head of the driver D or the like that is thrust by the impact upon an oblique collision comes into contact with the driver's airbag 10 and, consequently, a relatively large forward load is input to the steering wheel 30, the shock absorbing function of the steering wheel support mechanism 31 described earlier is actuated and the steering wheel 30 moves forward by a prescribed amount. FIG. 8A shows a case where the driver's airbag 10 has deployed from the steering wheel 30 prior to moving forward (in an initial state), and FIG. 8B shows a case where the driver's airbag 10 has deployed from the steering wheel 30 after moving forward. As is apparent from FIGS. 8A and 8B, in an initial state where the steering wheel 30 has not moved forward, even when the driver's airbag 10 deploys, the outer edge portion 10a thereof is arranged at a position slightly offset to the rear from the recessed portion Q of the curtain airbag 20 (refer to FIG. 8A). In comparison, when the steering wheel 30 moves forward due to an oblique collision, since the driver's airbag 10 also moves forward accordingly, the outer edge portion 10a of the driver's airbag 10 exactly penetrates into the recessed portion Q (refer to FIG. 8B).

In addition, in the state where the steering wheel 30 has moved forward, the driver's airbag 10 comes into contact with the front end cell portion 23 of the curtain airbag 20 positioned on the front side of the driver's airbag 10.

As described above, the airbag apparatus according to the present embodiment includes the driver's airbag 10 and the curtain airbag 20 that deploy upon an oblique collision of a vehicle. The curtain airbag 20 includes the front end cell portion 23 that deploys so as to wrap around to the front side of the outer edge portion 10a of the driver's airbag 10 (so as to protrude towards the inside of the cabin). Due to such a configuration, since a forward displacement of the outer edge portion 10a of the driver's airbag 10 can be restricted by the front end cell portion 23, the head of the driver D can be properly received by the driver's airbag 10 and the driver D can be protected in an effective manner.

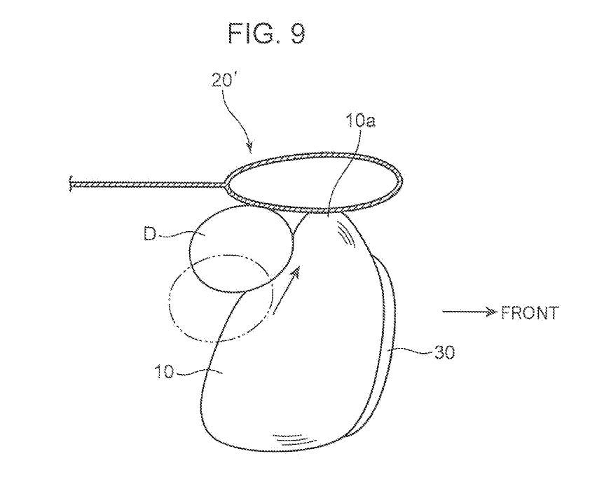

For example, as in the case of a comparative example shown in FIG. 9, when deploying a curtain airbag 20′ without a portion that wraps around to the front side of the outer edge portion 10a of the driver's airbag 10, the forward displacement of the outer edge portion 10a of the driver's airbag 10 is not restricted. Therefore, in response to the head of the driver D or the like that is thrust obliquely forward due to an impact load received upon an oblique collision coming into contact with a rear surface of the driver's airbag 10, the closer to the curtain airbag 20′, the more sharply the rear surface of the driver's airbag 10 inclines forward. As a result, as indicated by an arrow in FIG. 9, the head of the driver D moves toward an outer side in a vehicle width direction along a rear surface of the inclined driver's airbag 10. When the head of the driver D moves in such a direction, the driver's airbag 10 is no longer capable of receiving the head of the driver D with sufficient counter force and the head of the driver D can no longer be sufficiently restrained. This means that the driver D can no longer be protected in an appropriate manner.

In contrast, in the embodiment described above, since the driver's airbag 10 can be prevented from incliningly deforming like the comparative example (FIG. 9) by the front end cell portion 23 of the curtain airbag 20 that deploys so as to wrap around to the front side of the outer edge portion 10a of the driver's airbag 10, impact can be absorbed while receiving the head of the driver D with sufficient counter force and the driver D can be protected in an appropriate manner upon an oblique collision of the vehicle.

In addition, in the embodiment described above, the curtain airbag 20 has the recessed portion Q between the front area portion 20A including the front end cell portion 23 and the rear area portion 20B to the rear side of the front area portion 20A, and the recessed portion Q is formed at a position corresponding to the outer edge portion 10a of the driver's airbag 10. According to this configuration, due to the outer edge portion 10a of the driver's airbag 10 penetrating into the recessed portion Q of the curtain airbag 20, the inclining deformation of the driver's airbag 10 described above can be prevented more reliably and the driver D can be more effectively protected upon an oblique collision of the vehicle.

In particular, in the embodiment described above, the steering wheel support mechanism 31 is equipped with a shock absorbing function that causes the steering wheel 30 to move forward by a prescribed amount upon an oblique collision of the vehicle, and the recessed portion Q is formed at a position that enables penetration by the outer edge portion 10a of the driver's airbag 10 in a state where the steering wheel 30 has moved forward in this manner. According to this configuration, by causing the steering wheel 30 to move forward upon an oblique collision of the vehicle, the inclining deformation of the driver's airbag 10 can be prevented more reliably by the recessed portion Q while proactively mitigating impact that acts on the driver D.

In addition, in the embodiment described above, the front end cell portion 23 of the curtain airbag 20 deploys to a position where the front end cell portion 23 comes into contact with the driver's airbag 10 in a state where the steering wheel 30 has moved forward as described above. According to this configuration, the inclining deformation of the driver's airbag 10 can be prevented more reliably by the front end cell portion 23 while securing an amount of forward movement of the steering wheel 30 and the driver D can be protected more appropriately.

In the embodiment described above, while the front end cell portion 23 corresponding to the wraparound portion according to the present invention and the first front cell portion 24a forming a separate space from the front end cell portion 23 are provided as the front area portion 20A of the curtain airbag 20, at least a portion (the front end cell portion 23) corresponding to the wraparound portion need only be present as the front area portion 20A and the first front cell portion 24a may be omitted.

In addition, in the embodiment described above, while an example where the driver's airbag 10 that deploys rearward from the steering wheel 30 is provided as the first airbag according to the present invention and the curtain airbag 20 that deploys downward from the roof side rail 7 and the like is provided as the second airbag according to the present invention has been described, specific examples of the first airbag and the second airbag are not limited thereto. For example, the first airbag may be a front passenger seat airbag that deploys rearward from an instrument panel at a portion further on a front side from the front passenger seat. In addition, the second airbag need only be an airbag that deploys at a position to the outer side in the vehicle width direction relative to the first airbag and may be, for example, an airbag that deploys from a side door or the like.

Finally, characteristic configurations and operations and effects based on such configurations disclosed in the embodiment described above will be summarized.

The airbag apparatus according to the embodiment described above is designed to protect an occupant upon an oblique collision of a vehicle, and includes a first airbag which is provided in front of the occupant and which deploys rearward upon an oblique collision and a second airbag which is provided on the lateral side of the occupant and which deploys so as to cover a cabin side wall upon an oblique collision. The second airbag includes a wraparound portion which deploys so as to protrude towards the inside of the cabin at a position further on a front side from an outer edge portion that is a portion opposing the cabin side wall of a peripheral edge of the deployed first airbag to restrict the outer edge portion from being displaced forward.

According to this configuration, since the wraparound portion of the second airbag deploys at a position further on a front side from the outer edge portion of the first airbag and forward displacement of the outer edge portion is restricted by the wraparound portion, a large inclining deformation of a rear surface of the first airbag with which the head of the occupant or the like comes into contact can be effectively prevented. Accordingly, the head of the occupant can be received with sufficient counter force by the first airbag and the occupant can be appropriately protected upon an oblique collision of the vehicle.

Favorably, the second airbag includes a front area portion that deploys at a position further on a front side from the outer edge portion of the first airbag and a rear area portion that deploys to the rear side of the outer edge portion of the first airbag, and at least a portion of the front area portion functions as the wraparound portion.

According to this configuration, since an occupant can be prevented from colliding with the cabin side wall by the rear area portion while preventing the first airbag from incliningly deforming as described above by the wraparound portion constituted by at least a portion of the front area portion, the occupant can be more effectively protected upon an oblique collision of the vehicle.

Favorably, the second airbag includes a recessed portion that is recessed towards the cabin side wall at a boundary position between the front area portion and the rear area portion.

According to this configuration, due to the outer edge portion of the first airbag penetrating into the recessed portion of the second airbag, the inclining deformation of the first airbag can be prevented more reliably and the occupant can be protected even more effectively.

Favorably, the first airbag deploys rearward from a steering wheel provided in front of the driver's seat. The steering wheel is supported so as to be movable forward in accordance with a load applied to the steering wheel upon an oblique collision, and the wraparound portion deploys to a position where the wraparound portion comes into contact with the first airbag in a state where the steering wheel has moved forward.

According to this configuration, since the steering wheel moves forward upon an oblique collision of the vehicle, impact caused when the head of an occupant (driver) or the like comes into contact with the first airbag can be proactively mitigated by the forward movement of the steering wheel. In addition, since the wraparound portion comes into contact with the first airbag in a state where the steering wheel has moved forward in this manner, the inclining deformation of the first airbag can be prevented more reliably by the wraparound portion while securing an amount of forward movement of the steering wheel and the occupant can be protected more appropriately.

This application is based on Japanese Patent application No. 2015-004043 filed in Japan Patent Office on Jan. 13, 2015, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An airbag apparatus for protecting an occupant upon an oblique collision of a vehicle, the airbag apparatus comprising:
a first airbag which is provided in front of the occupant and which deploys rearward upon the oblique collision; and
a second airbag which is provided on a lateral side of the occupant and which deploys so as to cover a cabin side wall upon the oblique collision, wherein
the second airbag includes a wraparound portion which deploys so as to protrude towards an inside of the cabin at a position further on a front side from an outer edge portion that is a portion, opposing the cabin side wall, of a peripheral edge of the deployed first airbag to restrict the outer edge portion from being displaced forward.

2. The airbag apparatus according to claim 1, wherein
the second airbag includes a front area portion that deploys to the front side of the outer edge portion of the first airbag and a rear area portion that deploys to a rear side of the outer edge portion of the first airbag, and at least a portion of the front area portion functions as the wraparound portion.

3. The airbag apparatus according to claim 2, wherein
the second airbag includes a recessed portion that is recessed towards the cabin side wall at a boundary position between the front area portion and the rear area portion.

4. A vehicle equipped with:
the airbag apparatus according to claims 1; and
a steering wheel provided in front of a driver's seat, wherein
a first airbag deploys rearward from the steering wheel,
the steering wheel is supported so as to be movable forward in accordance with a load applied to the steering wheel upon an oblique collision, and
a wraparound portion deploys to a position where the wraparound portion comes into contact with the first airbag in a state where the steering wheel has moved forward.
